(19) United States
(12) Patent Application Publication
(10) Pub. No.: US 2013/0022054 A1
(43) Pub. Date: Jan. 24, 2013

(54) COMMUNICATION SYSTEM AND METHOD FOR A RAIL VEHICLE

(71) Applicants: Todd Goodermuth, Melbourne, FL (US); Jared Cooper, Melbourne, FL (US); Mark Kraeling, Melbourne, FL (US); Joseph Forrest Noffsinger, Grain Valley, MO (US); Glenn Shaffer, Erie, PA (US)

(72) Inventors: Todd Goodermuth, Melbourne, FL (US); Jared Cooper, Melbourne, FL (US); Mark Kraeling, Melbourne, FL (US); Joseph Forrest Noffsinger, Grain Valley, MO (US); Glenn Shaffer, Erie, PA (US)

(21) Appl. No.: 13/186,651

(22) Filed: Jul. 20, 2011

(51) Int. Cl. H04L 12/28

(52) U.S. Cl. 370/431

(57) ABSTRACT

A method of communicating data signals includes receiving data from one or more data sources disposed on board a rail vehicle and allocating different portions of a data communication bandwidth to data signals that include the data based on categories of the data. The categories represent at least one of the one or more data sources that provided the data or contents of the data. The data communication bandwidth includes a bandwidth that is available on a communication pathway of the rail vehicle. The method also includes transmitting the data signals through the communication pathway using the portions of the bandwidth that are assigned to the data signals.

### BACKGROUND OF THE INVENTION

Known powered rail vehicle consists (e.g., trains) include one or more powered units, such as locomotives, and one or more non-powered units, such as cargo cars. The powered units supply tractive force to propel the consists. Some known consists include several powered units. The powered units and/or non-powered units may communicate data signals between each other during a trip of the consist. For example, an operator on a first locomotive may change or vary a throttle setting or a brake setting on a different, second locomotive in the consist. The change in setting may be conveyed from the first locomotive to the second locomotive as a data signal. As another example, other data may be obtained and communicated between units of the consist, such as by sensors and other devices.

The medium through which the data may be transmitted between units may have a fixed bandwidth. For example, conductive wires may have a finite bandwidth that limits how much data can be transmitted through the wires over a given time period. Damage and/or increased data traffic on the medium can decrease the bandwidth that is available to transmit data through the medium. If the bandwidth becomes too limited, some of the data may not be successfully communicated between the units.

Some of the data that is communicated between the units of the consist can be of significant importance. For example, data that relates to controlling movement and/or safety limitations of the consist may be relatively important. The failure to successfully communicate such data can result in injury to persons and/or damage to the consist or nearby equipment and property. If the bandwidth of the medium used to communicate the data becomes too limited, some of the relatively important data may not be successfully delivered. As a result, the reliability of communicating the data via the medium is compromised.

A need exists to increase the reliability in communicating data between units of a consist, such as to increase the reliability in communicating data in a medium with a limited bandwidth.

### BRIEF DESCRIPTION OF THE INVENTION

In one embodiment, a communication system for a first rail vehicle is provided. The system includes a bandwidth module and a transceiver module. As used herein, the term “module” includes a hardware and/or software system that operates to perform one or more functions. For example, a module may include a computer processor, controller, or other logic-based device that performs operations based on instructions stored on a tangible and non-transitory computer readable storage medium, such as a computer memory. Alternatively, a module may include a hard-wired device that performs operations based on hard-wired logic of the device. The modules shown in the attached figures may represent the hardware that operates based on software or hardwired instructions, the software that directs hardware to perform the operations, or a combination thereof.

In an embodiment, the bandwidth module is configured to allocate different portions of a data communication bandwidth of a communication pathway to data signals; the data signals include data received from one or more data sources disposed on board the first rail vehicle. The allocation is based on categories of the data. The categories represent contents of the data and/or the data sources. The transceiver module is configured to transmit the data signals through the communication pathway using the portions of the bandwidth that are allocated to the data signals.

In another embodiment of the communication system, the system further includes an input module configured to be operatively coupled with at least one of the bandwidth module or the transceiver module. The input module is also configured to receive the data from the one or more data sources disposed on board the first rail vehicle. In embodiments, the input module, bandwidth module, and the transceiver module are integrated together as part of a common electronics unit or module.

In another embodiment, a method of communicating data signals with a first rail vehicle is provided. The method includes receiving data from one or more data sources disposed on board the first rail vehicle and allocating different portions of a data communication bandwidth to data signals that include the data, based on categories of the data. The categories represent the one or more data sources and/or the contents of the data. The data communication bandwidth includes a bandwidth that is available on a communication pathway of the first rail vehicle. The method also includes transmitting the data signals through the communication pathway using the portions of the bandwidth that are assigned to the data signals.

In another embodiment, a computer readable storage medium having one or more sets of instructions is provided. The one or more sets of instructions direct the processor to receive data from one or more data sources disposed on board a first rail vehicle and allocate different portions of a data communication bandwidth to data signals that include the data based on categories of the data. The categories represent the one or more data sources and/or the contents of the data. The data communication bandwidth includes a bandwidth that is available on a communication pathway of the first rail vehicle. The one or more sets of instructions also direct the processor to transmit the data signals through the communication pathway using the portions of the bandwidth that are assigned to the data signals.

### BRIEF DESCRIPTION OF THE DRAWINGS

FIG. 1 is a schematic illustration of one embodiment of a rail vehicle consist.

FIG. 2 is a schematic diagram of one embodiment of a communication system that communicates data signals between a first rail vehicle and a second rail vehicle of the consist shown in FIG. 1.

FIG. 3 is a schematic diagram of the rail vehicle shown in FIG. 2 coupled with a communication pathway shown in FIG. 1 in accordance with one embodiment.

FIG. 4 is a schematic diagram of a multiple unit cable shown in FIG. 3 in accordance with one embodiment.

FIG. 5 is a flowchart of one embodiment of a method for communicating data signals in a vehicle consist.

### DETAILED DESCRIPTION OF THE INVENTION

The foregoing summary, as well as the following detailed description of certain embodiments of the inventive subject matter, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

Example embodiments of systems and methods that allocate portions of a data communication bandwidth of a communication pathway extending between rail vehicles for the communication of different categories of data signals are provided. As used herein, “data” refers to information that is conveyed or communicated in a “data signal.” A data signal may include additional information that is used to convey or communicate the data. For example, a sensor may generate a measurement of speed as data. The speed measurement may be packetized in one or more packets that include additional information, such as header portions of the packets that specify recipients and/or orders of the packets. The packets may represent the data signals that are used to convey the data.

At least one technical effect described herein includes a method and system that changes the priority of data signals communicated between rail vehicles in the same consist to ensure or increase the probability that the contents of the data signals (e.g., control information used to direct tractive efforts of a rail vehicle) are received by a receiving rail vehicle. Some of the data that is communicated in the data signals according to the different priorities of several data signals can be used to direct tractive efforts and/or braking efforts supplied by the receiving rail vehicle.

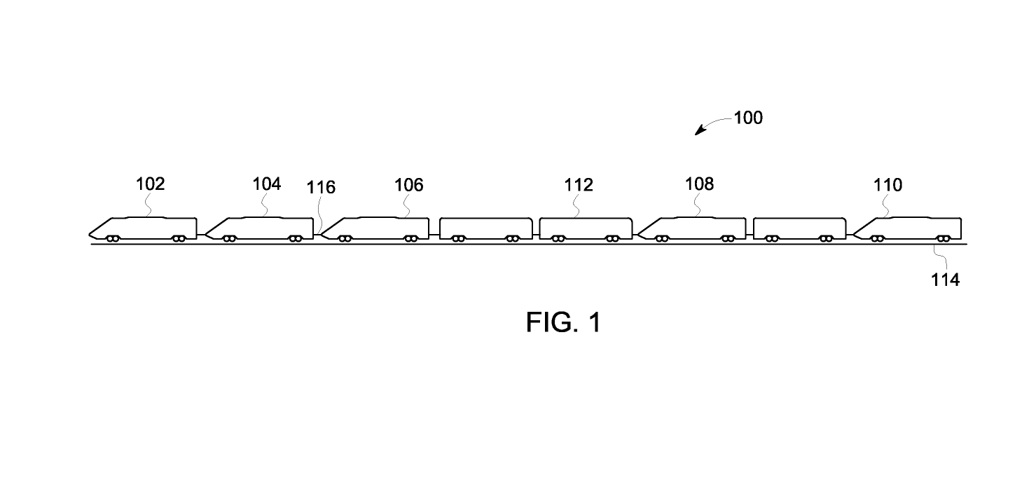

FIG. 1 is a schematic illustration of one embodiment of a vehicle consist 100. The consist 100 shown in FIG. 1 is a rail vehicle consist (e.g., a train or part of a train), but alternatively may be a non-rail vehicle consist. The consist 100 includes a lead powered unit 102 mechanically coupled with several trailing or remote powered units 104, 106, 108, 110 and non-powered units 112. The consist 100 travels along a track 114. The powered units 102, 104, 106, 108, 110 and/or non-powered units 112 may be referred to as rail vehicles of the consist 100. A vehicle consist is a group of one or more powered units (such as locomotives) or other vehicles that are mechanically coupled or linked together to travel along a route, with each vehicle in the consist being adjacent to one or more other vehicles in the consist. A consist may include a single powered unit or multiple powered units. By way of example, a rail vehicle consist (e.g., train) may include several powered and non-powered units or cars (e.g., rail vehicles), with the powered units being capable of self-propulsion and the non-powered units being incapable of self-propulsion. A locomotive consist may include several powered units (e.g., locomotives) that coordinate the tractive and/or braking efforts provided by the powered units such that the locomotive consist operates as a single unit. The rail vehicle consist may include one or more locomotive consists.

The powered units 102, 104, 106, 108, 110 supply tractive forces to propel the consist 100 along the track 114. In one embodiment, the consist 100 includes the lead powered unit 102 as a leading locomotive disposed at the front end of the consist 100; alternatively, the lead powered unit 102 may be located intermediate in the consist 100. In either case, the lead powered unit 102 is the lead in terms of consist operation. The non-powered units 112 may be cars for carrying cargo (e.g., goods and/or passengers) along the track 114. The other powered units 104, 106, 108, 110 in the consist 100 may be remote powered units or trail powered units, depending on where in the consist they are located and/or on how they are functionally linked with other powered units. In the example of FIG. 1, the powered units 104, 106 are trail powered units, and the powered units 108, 110 are remote powered units. A remote powered unit is one that is operationally linked (e.g., wirelessly) with the lead powered unit 102 for coordinated tractive effort (e.g., throttle or braking), in a distributed power system. Typically, remote powered units are not in the same powered unit consist (e.g., locomotive consist) as the lead powered unit 102 (e.g., a remote may be spaced apart from the lead consist by one or more non-powered units), but this is not necessarily the case. A trail powered unit is one that is in the same powered unit consist as another powered unit, and that is controlled by the other powered unit, such as through a cable that interconnects the two. The number of powered units 102, 104, 106, 108, 110 in the consist 100 may vary from those shown in FIG. 1.

As described below, the powered units 102, 104, 106, 108, 110 and/or non-powered units 112 may include data sources disposed on board the various powered units 102, 104, 106, 108, 110 and/or non-powered units. For example, the powered units 102, 104, 106, 108, 110 and/or non-powered units 112 may include sensors, radios, software applications, and other components that generate data. The data can represent the output of the data sources and can be communicated between the powered units 102, 104, 106, 108, 110 and/or non-powered units 112 in the consist 100 via data signals. For example, the data signals may include the data. The data signals can be communicated throughout the consist 100 via one or more communication pathways 116. The communication pathway 116 may comprise a conductive communication pathway, such as a wire or other conductor, or a group of wires or other conductors, e.g., a trainline or multiple unit (MU) cable, that extends through the consist 100 between the powered units 102, 104, 106, 108, 110 and/or the non-powered units 112. In another embodiment, the communication pathway 116 may be another type of communication link among or between the units 102, 104, 106, 108, 110, 112, such as one or more wireless connections in a wireless network.

The data that is communicated as data signals through the communication pathway 116 may be network data and/or high-bandwidth network data. Network data includes data that is communicated as data signals or data packets, such as according to the TCP/IP protocol. For example, the data may be transmitted in sequential packets of data having a header containing addressing information and an envelope containing information that is communicated using the data packets. Alternatively, the data may be communicated as non-network data, such as another type of data and/or another format of the data. “High-bandwidth network data” can include data transmitted at average rates of 10 Mbit/sec or greater, such as data that is packaged in packet form as data packets and transmitted at average rates of 10 Mbit/sec or greater. In contrast, “low bandwidth” data is data transmitted at average rages of less than 10 Mbit/sec, and “very low bandwidth” data (a type of low bandwidth data) is data transmitted at average rates of 1200 bits/sec or less.

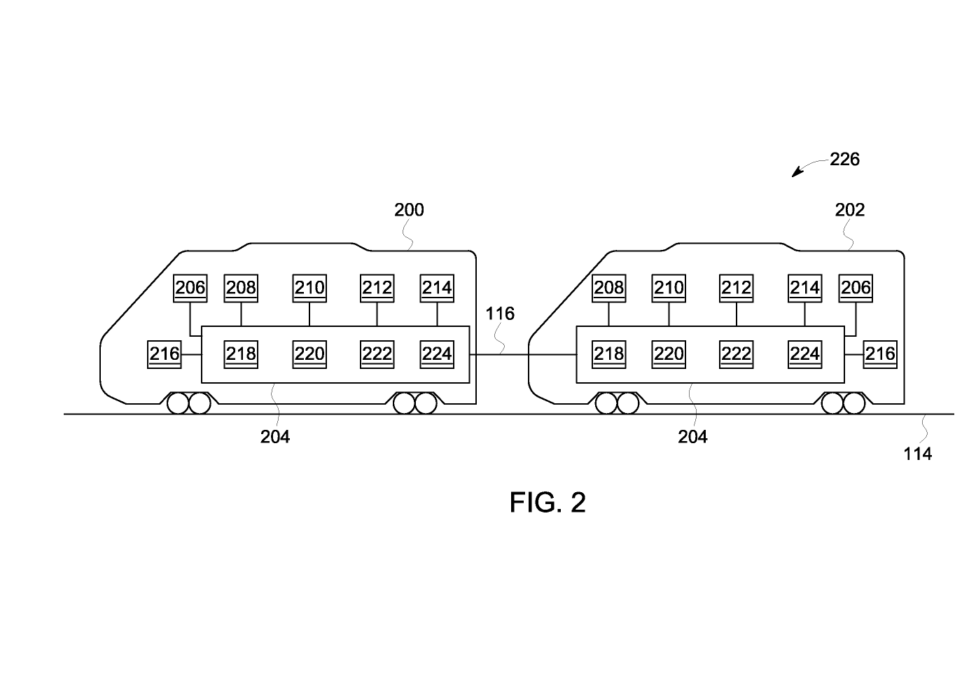

FIG. 2 is a schematic diagram of one embodiment of a communication system 226 that communicates data signals between a first rail vehicle 200 and a second rail vehicle 202 of the consist 100 shown in FIG. 1. The rail vehicles 200, 202 may represent two of the powered and/or non-powered units 102, 104, 106, 108, 110, 112 (shown in FIG. 1). For example, the rail vehicles 200, 202 may represent two of the powered and/or non-powered units 102, 104, 106, 108, 110, 112 adjacent to each other in the consist 100 shown in FIG. 1. Alternatively, the rail vehicles 200, 202 may be separated by one or more other powered and/or non-powered units 102, 104, 106, 108, 110, 112. As described above, the communication pathway 116 extends between the rail vehicles 200, 202 to permit communication of data signals between the rail vehicles 200, 202.

In the illustrated embodiment, the rail vehicles 200, 202 include propulsion subsystems 216 that provide tractive effort and/or braking effort to propel the rail vehicles 200, 202. The propulsion subsystems 216 can represent one or more traction motors, engines (e.g., diesel engines), and/or brakes that propel, accelerate, decelerate, and/or stop movement of the consist 100 (shown in FIG. 1). Alternatively, one or more of the rail vehicles 200, 202 may not include a propulsion subsystem 216.

The system 226 includes processors 204 disposed on board the rail vehicles 200, 202. The processor 204 may include computer processors, microprocessors, controllers, microcontrollers, or other hardware devices. For example, the processors 204 can be programmable logic-based devices; dedicated, hard-wired state machines; or a combination thereof. The reference number 204 can refer to a single processor or multiple processors, arithmetic-logic units (ALUs), central processing units (CPUs), or the like, disposed on board each of the rail vehicles 200, 202. The processors 204 operate based on one or more sets of instructions. The one or more sets of instructions can include one or more software applications or programs stored on computer readable storage media disposed on board the rail vehicles 200, 202, such as memories 206. The memories 206 may be tangible and non-transitory computer readable storage media, such as solid-state, electromagnetic, and/or optical memories. The memories 206 can be volatile, nonvolatile, or a mixture thereof. Some or all of the memories 206 can be portable, such as a disk, card, memory stick, cartridge, and the like.

The processors 204 are communicatively coupled with one or more data sources of the system 226. For example, the processors 204 may be capable of communicating with data sources disposed on board the same rail vehicle 200, 202 and/or with one or more data sources disposed on another rail vehicle by wired and/or wireless connections, such as busses, wires, wireless networks, and the like. In the illustrated embodiment, the data sources disposed on board each rail vehicle 200, 202 include a sensor 208, an input device 210, a control device 212, and a computer application 214. Alternatively, one or more other data sources may be disposed on the first and/or second rail vehicles 200, 202. In one embodiment, the data sources disposed on each of the rail vehicles 200, 202 may differ from the data sources disposed on board the other rail vehicle 202, 200.

The sensor 208 includes a device capable of sensing or measuring a state or condition of a component and producing data representative of the sensed or measured state or condition. For example, the sensors 208 can include active and/or passive sensors that monitor one or more characteristics of the rail vehicles 200, 202. The sensors 208 may provide data that represents a health or status of one or more of the rail vehicles 200, 202. For example, the sensors 208 may monitor the propulsion subsystems 216, such as by monitoring the traction motors, engines, and/or brakes of the propulsion subsystems 216. Alternatively, the sensors 208 may include one or more other devices that provide data representative of a health, status, or condition of one or more other components of the rail vehicles 200, 202. The sensors 208 may generate data that is to be communicated to one or more other rail vehicles 200, 202.

The input devices 210 include one or more components that receive input from an outside source and generate data based on the input. The input devices 210 can be devices that are used by human operators of the rail vehicles 200 and/or 202 to provide input into the system 226. By way of example, the input devices 210 can include keyboards, touchscreens, microphones, styluses, an electronic mouse, and the like. Alternatively, the input devices 210 may be devices that receive data in data signals communicated from one or more other rail vehicles, such as the rail vehicle 202. For example, the input device 210 can include an antenna and/or coupling with the communication pathway 116 to receive data from another rail vehicle. The input devices 210 may generate data that is to be communicated to one or more other rail vehicles 200, 202.

The control device 212 includes a device that is used to control tractive operations of the propulsion subsystem 216. For example, the control device 212 may include a computer processor and one or more sets of instructions (e.g., software applications) that direct the computer processor to change tractive effort and/or braking effort supplied by the propulsion subsystem 216. The control device 212 may automatically control operations of the propulsion subsystem 216, such as by changing the tractive efforts and/or braking efforts according to instructions received from another rail vehicle 200 or 202 (e.g., in a distributed power arrangement of the consist 100 shown in FIG. 1), instructions received from the operator via the input device 210, and/or a trip profile. The trip profile may be a series of settings for the propulsion subsystem 216 (e.g., throttle and brake settings) that are automatically implemented by the control device 212 during a trip of the consist 100. For example, the trip profile may include different throttle settings based on a variety of factors, such as speed limits in different portions of the trip, emission limits, tonnage of cargo being conveyed, grade and/or curvature of the track 114, and the like. The control device 212 may generate data that is to be communicated with the control device 212 and/or one or more other components on another rail vehicle 200, 202, such as to control tractive efforts of another rail vehicle 200, 202.

The computer application 214 includes a device that performs one or more functions related to or dependant upon the operations of the rail vehicle 200 or 202. For example, the computer application 214 may represent a computer processor and one or more sets of instructions that direct the processor to measure conditions of the rail vehicle 200 or 202 (e.g., throttle settings, current speed, brake pressure, temperature, horsepower, and the like) and use the measured conditions for one or more purposes, such as for calculating fuel efficiency, tracking performances of the operator of the rail vehicle 200, 202, providing safety features (e.g., speed limits), and the like, for the rail vehicle 200, 202. The computer applications 214 on different rail vehicles 200, 202 may generate and communicate data with each other and/or with one or more other components on another rail vehicle 200, 202.

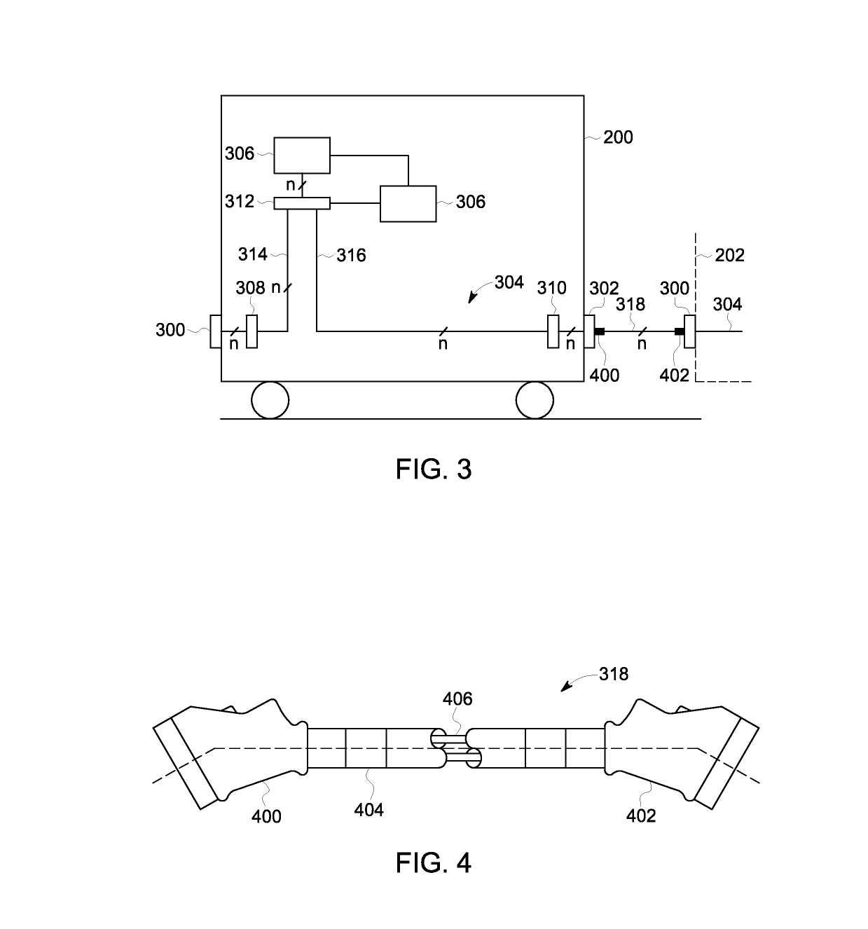

FIG. 3 is a schematic diagram of the rail vehicle 200 coupled with the communication pathway 116 in accordance with one embodiment. As described above, the communication pathway 116 may include one or more MU cables 318 disposed between adjacent rail vehicles 200, 202. The MU cable 318 may be an existing electrical bus interconnecting the rail vehicles 200, 202 of the consist 100 shown in FIG. 1. To interface with the MU cable 318, the rail vehicles 200, 202 may include first and second connectors 300, 302 and internal electrical systems 304 that connect the connectors 300, 302 to one or more electronic components 306, such as the processors 204 and/or the data sources. For example, the single electronic component 306 shown in FIG. 3 may represent the processor 204 and/or one or more of the data sources disposed on board the rail vehicle 200. In the illustrated example, the electrical system 304 includes a first terminal board 308 electrically connected to the first connector 300, a second terminal board 310 electrically connected to the second connector 302, a third terminal board 312, and first and second electrical conduit portions 314, 316 electrically connecting the third terminal board 312 to the first terminal board 308 and the second terminal board 310, respectively. The electronic components 306 may be conductively coupled to the third terminal board 312, and thereby to the MU cable 318 generally.

Continuing with the discussion of the rail vehicle 200 and the MU cable 318 shown in FIG. 3, FIG. 4 is a schematic diagram of the MU cable 318 in accordance with one embodiment. The MU cable 318 includes first and second plug ends 400, 402 and a flexible cable portion 404 conductively and mechanically connecting the plug ends 400, 402 together. The plug ends 400, 402 fit into the connectors 300, 302. The MU cable 318 may be electrically symmetrical, meaning either plug end 400, 402 can be attached to either port 300, 302. The MU cable 318 can be used to electrically interconnect the internal electrical systems 304 of adjacent rail vehicles 200, 202. As such, for each adjacent pair of rail vehicles 200, 202, the first plug end 400 of the MU cable 318 is attached to the second port 302 of the rail vehicle 200, and the second plug end 402 of the MU cable 318 is attached to the first port 300 of the rail vehicle 303. Moreover, non-adjacent rail vehicles in the consist 100 shown in FIG. 1 can communicate with each other via the MU cable 318 between adjacent rail vehicles and the internal electrical systems 304 of the rail vehicles. The flexible cable portion 404 of the communication pathway 404 extends between the plug ends 400, 402 to provide a flexible but secure electrical connection between the rail vehicles 200, 202.

Depending on the particular type and configuration of rail vehicles 200, 202, the electrical conduit portions 314, 316 and the MU cable 318 may be configured in different manners, in terms of the number “n” (“n” is a real whole number equal to or greater than 1) and type of discrete conductive pathways (e.g., wires or busses) included in the conduit portion 314, 316 or MU cable 318. In one example, each conduit portion 314, 316 and the MU cable 318 includes a plurality of discrete conductive physical portions 406 (shown in FIG. 4). In one embodiment the physical portions 406 may be conductive wires, such as 12-14 gauge copper wires. By “discrete,” it is meant that the physical portions 406 may not be conductively coupled with each other within the MU cable 318 from the plug end 400 to the plug end 402. In another example, the cable portion 404 of the MU cable 318 includes a plurality of discrete physical portions 406 (e.g., wires that are not conductively coupled with each other between the plug ends 400, 402, while the conduit portions 314, 316 each include one or more discrete electrical wires and/or non-wire electrical pathways, such as conductive structural components of the rail vehicles 200, 202, pathways through or including electrical or electronic components, circuit board traces, or the like. Although certain elements in FIG. 3 are shown as including “n” discrete electrical pathways, it should be appreciated that the number of discrete pathways in each element may be different, i.e., “n” may be the same or different for each element.

As noted, the plug ends 400, 402 of the MU cable 318 mate with the connectors 300, 302. For this purpose, the plug ends 400, 402 and the connectors 300, 302 can be complementary in shape to one another, both for mechanical and electrical attachment. The plug ends 400, 402 may include a plurality of electrical pins, each of which fits into a corresponding electrical socket in an connector 300, 302. The number of pins and sockets may depend on the number of discrete electrical pathways extant in the internal electrical conduits 314, 316, MU cables 318, etc. In one example, each plug end 400, 402 is a twenty seven-pin plug.

The terminal boards 308, 310, 312 may each comprise an insulating base (attached to the rail vehicle 200, 202) on which terminals for wires or cables have been mounted. This provides flexibility in terms of connecting different electronic components to the MU cable 318. The term “communication pathway” can refer to the entire communication pathway 116 or any portion(s) thereof, e.g., terminal boards, connectors, jumper cable, conduit portions, and the like. When two or more rail vehicles are connected via the MU cable 318, both the MU cable 318, the internal electrical systems 304 of the rail vehicles 200, 202, and the MU cables 318 that connect other pairs or groups of rail vehicles together may form the communication pathway 116. As subsequent locomotives are attached using additional MU cables 318, those MU cables 318 and the internal electrical systems 304 of the subsequent rail vehicles may also become part of the communication pathway.

In one embodiment, the internal electrical systems 304 may include router transceiver units that transmit and/or receive the data signals through the communication pathway 116 between the rail vehicles. The router transceiver units may be similar to the router transceiver units 34a, 34b, 34c shown and described in U.S. Patent Application Publication No. 2010/0241295, filed Jan. 7, 2010, and entitled “System And Method For Communicating Data In Locomotive Consist Or Other Vehicle Consist” (the “'295 application”). The entire disclosure of the '295 application is incorporated by reference herein.

Returning to the discussion of the processors 204, the processors 204 receive data from one or more of the data sources described above and/or from one or more other data sources and communicate the data in data signals to another rail vehicle. For example, the processor 204 of the first rail vehicle 200 may transmit data signals that include data from one or more data sources 208, 210, 212, 214 of the first rail vehicle 200 to the processor 204 of the second rail vehicle 200. The data signals can be transmitted through one or more wired and/or wireless connections, such as through the communication pathway 116. Alternatively, the processor 204 may transmit the data signals to one or more other rail vehicles of the consist 100 shown in FIG. 1.

One or more of the processors 204 on the rail vehicles 200, 202 may include several functional modules that perform various operations to communicate the data signals between rail vehicles of the consist 100 (shown in FIG. 1). The modules may be embodied in one or more sets of instructions stored in the memory 206 of the corresponding rail vehicle 200, 202. In the illustrated embodiment, the processors 204 include input modules 218 that receive data from the data sources. For example, the processors 204 may be communicatively coupled with the sensors 208, input devices 210, control devices 212, and computer applications 214 disposed on the same rail vehicle 200, 202 by one or more wired and/or wireless connections. The input modules 218 may receive data from the data sources disposed on board the same rail vehicle 200, 202. Alternatively, the input modules 218 may receive data from one or more other data sources and/or from one or more data sources disposed on a different rail vehicle 200, 202.

In one embodiment, a prioritization module 220 assigns different priority ranks to the data signals used to convey the data received from the data sources. The priority ranks may be assigned to the data signals based on one or more categories of the data that is transmitted in the data signals. For example, the prioritization module 220 can associate data received from the data sources with one or more categories and assign the same or similar priority ranks to data associated with the same category. The categories can be customizable and changed over time. As one example, the categories can include, but are not limited to, a: first category, comprising data associated with controlling operations of a propulsion subsystem of one or more of a first rail vehicle or a different, second rail vehicle (referred to herein as the control category); a second category, comprising data associated with enforcement of a safety limitation on operations of one or more of the first rail vehicle or the second rail vehicle (referred to herein as the safety category); a third category, comprising data representative of information about at least one of a state or condition of one or more of the first rail vehicle or the second rail vehicle (referred to herein as the informational category); and/or a fourth category, comprising data used by one or more software applications (referred to herein as the software application category). The categories can additionally or alternatively include a fifth, third party category (comprising data that is requested by and/or used by one or more third party software applications), and a sixth, inherent category (comprising data that is requested by and/or used by one or more software applications provided by the manufacturer or supplier of the rail vehicle). One or more additional categories may be used. In one embodiment, a seventh, “other” category may include data that is not included in one or more other categories.

The control category includes data that relates or is used to control operations of the rail vehicle 200, 202. For example, the control category may include instructions to change one or more settings of the propulsion subsystem 216 of a rail vehicle 200, 202. In operation, the first rail vehicle 200 may transmit instructions to the second rail vehicle 202 to change a throttle setting, a brake setting, or some other setting that controls tractive operations of the second rail vehicle 202. These instructions may be associated with the control category by the prioritization module 220 prior to transmitting the instructions in data signals from the first rail vehicle 200 to the second rail vehicle 202.

The informational category includes data that provides information about a state or condition of one or more of the rail vehicles 200, 202. For example, the informational category may include fuel levels, speeds, temperatures, horsepower, and the like, of one or more of the rail vehicles 200, 202. In one embodiment, the data in the informational category may not include directions or instructions to change, vary, or maintain a setting or other state or condition of the propulsion subsystem 216.

The safety category includes data that may be used for the safe operation of the rail vehicle 200, 202. For example, the data in the safety category may be used to prevent or avoid physical harm to bystanders, the rail vehicles 200, 202, other rail vehicles, nearby equipment, and the like, by enforcing one or more safety limitations (e.g., speed and/or geographical limitations) on the rail vehicles 200, 202. The data of the safety category may be used by the rail vehicles 200, 202 to control operations of the rail vehicles 200, 202. For example, the data in the safety category can include positive train control (PTC) information that is used to monitor and/or control movements of one or more of the rail vehicles 200, 202 and/or the consist 100 shown in FIG. 1. The PTC information may represent geographic locations of the rail vehicles 200, 202 and/or consist 100 relative to boundaries that represent restricted areas that the rail vehicles 200, 202 and/or consist 100 are not permitted due to safety limitations (e.g., the presence of another consist on the track 114). As another example, the PTC information may represent current speeds of the rail vehicles 200, 202 and/or consist 100 relative to speed limits associated with different geographic areas. The data in the safety category can be used to change operations of the rail vehicle 200, 202, such as to stop movement of the rail vehicle 200 and/or 202 when the rail vehicle 200, 202 approaches or enters a restricted area, to slow down movement of the rail vehicle 200 and/or 202 when the rail vehicle 200, 202 approaches a reduced speed limit, and the like. Other information in addition to the above examples may be data in the safety category.

The third party category includes data that is requested by and/or used by one or more third party software applications to perform one or more operations. For example, the computer application 214 may be a third party software application, such as a software application provided by an entity or party other than the manufacturer or supplier of the rail vehicle 200 and/or 202. The third party software application may use the data for a variety of purposes, such as for monitoring or tracking one or more states, conditions, or operations of the rail vehicle 200, 202.

The inherent category includes data that is requested by and/or used by one or more software applications provided by the manufacturer or supplier of the rail vehicle 200, 202. For example, the computer application 214 may be a software application that is pre-loaded or pre-existing on the rail vehicle 200, 202 when the rail vehicle 200, 202 is acquired, or is provided after acquisition of the rail vehicle 200, 202 by the manufacturer or supplier. The software application may use the data for a variety of purposes, such as for monitoring or tracking one or more states, conditions, or operations of the rail vehicle 200, 202. The third party category and the inherent category may collectively be referred to as a software application category.

In one embodiment, the prioritization module 220 assigns a low or relatively low priority rank to data of the third party category and a higher priority rank to the data of the inherent category. The prioritization module 220 may assign a priority rank to the informational category that is the same or higher than the priority rank of the inherent category. Alternatively, the data in at least a plurality of the third party category, the inherent category, and/or the informational category may be assigned the same priority rank. The prioritization module 220 can assign a higher priority rank to the data in the control category than the priority ranks of the third party category, the inherent category, and/or the informational category. The data of the safety category may be provided with a priority rank that is higher than one or all of the other categories. Alternatively, a different order of priority ranks may be assigned to the data of the different categories. In one embodiment, data may belong or be associated with a plurality of categories. The prioritization module 220 may assign the priority rank that is greatest among the plurality of categories to which the data is associated, or at least a priority rank that is greater than one or more of the other categories to which the data is associated.

The prioritization module 220 can assign different data to the different categories in a variety of manners. In one embodiment, different data sources may have electrical connectors that mechanically and electrically couple the data sources with the processor 204, or with a housing that includes the processor 204. For example, the data sources may be connected to connector plugs that are received in different connector sockets. The prioritization module 220 may identify which socket is used to receive data and, based on the socket, assign the data to a particular category. As different data sources can be coupled with different sockets, the data from the different data sources can be associated with different categories.

In another embodiment, the prioritization module 220 can assign different data to the different categories based on identifiers of the data sources. For example, the different data sources may be associated with identifiers, such as Internet Protocol (IP) addresses. The IP addresses may be unique or shared by two or more of the data sources. The prioritization module 220 may assign the data received from one or more data sources having one or more identifiers to a first category, the data received from other data sources having other identifiers to a second category, and so on.

A bandwidth module 222 allocates different portions of a data communication bandwidth that is available on the communication pathway 116 to the data signals. In one embodiment, the bandwidth module 222 allocates the portions of the bandwidth to the categories of data based on priority ranks associated with the categories. Alternatively, the bandwidth module 222 may allocate the portions of the bandwidth based on an amount of available bandwidth. The communication pathway 116 may have a bandwidth that represents a measurement of data communication resources that are available for communicating the data signals. The bandwidth may be expressed as a bit rate, or rate of communication of data through the communication pathway 116, such as bits per second, kilobits per second, and the like. In one embodiment, the communication pathway 116 has a bandwidth of 10 megabits per second. Alternatively, the communication pathway 116 may have a smaller or larger bandwidth. The bandwidth may be referred to as a channel capacity of the communication pathway 116.

The bandwidth of the communication pathway 116 may be allocated among different categories of data by dividing the available bandwidth into portions and assigning different portions and/or different sized portions to different categories. For example, the safety category may be assigned a first portion of the bandwidth, the control category may be assigned a second portion of the bandwidth, the informational category may be assigned a third portion of the bandwidth, and so on. In one embodiment, the portions of the bandwidth represent different subsets of the physical portions 406 (shown in FIG. 4) of the MU cable 318 (shown in FIG. 3) to the different categories. For example, if the MU cable 318 includes “n” physical portions 406, the bandwidth module 222 may dedicate or assign

$$\frac{n}{3}$$

of the physical portions 406 to a first subset of physical portions 406, another

$$\frac{n}{3}$$

of the physical portions 406 to a second subset, another

$$\frac{n}{6}$$

of the physical portions 406 to a third subset, and another

$$\frac{2 \times n}{6}$$

of the physical portions 406 to a fourth subset. The different subsets of the physical portions 406 may include non-overlapping subsets of the physical portions 406. For example, in one embodiment, no two subsets of the physical portions 406 include the same physical portion 406 or physical portions 406. Alternatively, a plurality of the subsets of the physical portions 406 may share one or more physical portions 406. Different categories of the data may be assigned to different subsets of the physical portions 406.

The bandwidth module 222 can allocate the different subsets of the physical portions 406 to the different categories of data in order to provide greater bandwidth to one or more of the categories than one or more other categories. For example, if the portions are the same size or approximately the same size (e.g., the portions have the same or approximately same number of physical portions 406), then the bandwidth module 222 can allocate a greater number of the portions of the physical portions 406 to a first category relative to a second category to provide the first category with greater bandwidth. Alternatively, if the portions are not the same size (e.g., the portions have different numbers of physical portions 406), then the bandwidth module 222 can allocate a portion having a larger number of physical portions 406 to a first category relative to a second category so that the first category has a greater bandwidth. As the number of physical portions 406 that is allocated to a category increases, the size of the bandwidth in the communication pathway 116 that is used to communicate data signals having data of the category increases. Conversely, as the number of physical portions 406 that is allocated to a category decreases, the size of the bandwidth in the communication pathway 116 that is used to communicate data signals having data of the category also may decrease.

In another embodiment, the bandwidth of the communication pathway 116 may be expressed as a range of frequencies that can be used to communicate data signals through the communication pathway 116. For example, the bandwidth may include a range of frequencies (Δf) extending from a lower frequency limit (f_{L}) to an upper frequency limit (f_{U}). The frequencies within the range of frequencies (Δf) may be grouped into subsets or channels, with each subset or channel representing a smaller range of the frequencies. For example, the bandwidth module 222 may allocate

$$\frac{Δ f}{3}$$

of the range of frequencies (Δf) to a first subset or channel, another

$$\frac{Δ f}{3}$$

of the range of frequencies (Δf) to a second subset or channel, another

$$\frac{Δ f}{6}$$

of the range of frequencies (Δf) to a third subset or channel, and another

$$\frac{2 \times Δ f}{6}$$

of the range of frequencies (Δf) to a fourth subset or channel. Different subsets or channels can be assigned to the different categories of data such that data signals conveying different categories of data are communicated using different subsets of the range of frequencies (Δf). In one embodiment, a plurality or all of the same physical portions 406 (shown in FIG. 4) of the communication pathway 116 may be used to communicate data signals having data of different categories at the same time, but with different subsets or channels of the range of frequencies (Δf).

The different subsets or channels of the range of frequencies (Δf) may include non-overlapping subsets of the range of frequencies (Δf). For example, in one embodiment, no two subsets or channels of the range of frequencies (Δf) include the same frequency. Alternatively, a plurality of the subsets or channels of the range of frequencies (Δf) may share one or more frequencies.

The bandwidth module 222 may allocate fixed portions of the bandwidth to the categories of data. For example, the bandwidth module 222 may assign different subsets of the physical portions 406 (shown in FIG. 4) and/or of the range of frequencies (Δf) to different categories prior to a trip of the consist 100 (shown in FIG. 1) (e.g., the movement of the consist 100 from a starting location to a destination location) and keep the allocation of the subsets among the categories the same for the remainder of the trip.

Alternatively, the bandwidth module 222 may dynamically allocate the portions of the bandwidth among the categories of data. For example, the bandwidth module 222 may initially assign different subsets of the physical portions 406 and/or of the range of frequencies (Δf) to different categories but change the size of the assigned portion of the bandwidth for one or more of the categories. The bandwidth module 222 may change the size of the portion of the bandwidth for a category by allocating a different number of physical portions 406 to communicating data signals having data of the category and/or by allocating a larger or smaller subset of the range of frequencies (Δf) to the communication of data signals having data of the category.

The bandwidth module 222 can dynamically allocate the bandwidth among the categories of data based on an operating condition of the rail vehicle 200 and/or 202. An operating condition represents a state or the occurrence of an event related to operations of the rail vehicle 200, 202. For example, application of an emergency brake, a shutdown (e.g. turning off) of an engine, failure of a traction motor, detection of impending failure of a traction motor, an unsafe increase or change in an engine temperature, and the like, may represent an emergency or abnormal operating condition of the rail vehicle 200, 202. When such an emergency or abnormal operating condition occurs, the bandwidth module 222 may increase the size and/or number of portions of the bandwidth that are allocated to one or more categories of data having higher priority ranks and/or reduce the size and/or number of portions of the bandwidth allocated to other categories having lower priority ranks. Detection of the operating condition of the rail vehicle 200, 202 may be provided by the input device 206 and/or one or more other data sources to the bandwidth module 222.

The bandwidth module 222 can dynamically allocate the bandwidth among the categories of data based on a failure rate of communication between the rail vehicle 200 or 200 and one or more other rail vehicles of the consist 100 (shown in FIG. 1). The failure rate of communication represents a frequency at which data signals transmitted by a first rail vehicle of the consist 100 do not reach, or are not received, by a different, second rail vehicle of the consist 100. With respect to data signals transmitted as a plurality of data packets, a data signal may not reach or be received when one or more of the data packets that are necessary to interpret the data signal do not reach the intended recipient. In one embodiment, the rail vehicles 200, 202 may transmit data signals and confirmation signals to each other. The data signals include data, as described above, and the confirmation signals may include indications that the data signals were successfully received. If a receiving first rail vehicle does not transmit a confirmation signal to a transmitting second rail vehicle, then a failure of communication may have occurred.

The input module 218 of a transmitting rail vehicle may track or monitor how often data signals are sent to another receiving rail vehicle without a confirmation signal being received from the receiving rail vehicle. If the frequency or number of times that confirmation signals are not received exceeds a threshold, then the input module 218 of the transmitting rail vehicle may notify the bandwidth module 222 of the transmitting rail vehicle. In response, the bandwidth module 222 may increase the size and/or number of portions of the bandwidth that are allocated to one or more categories of data transmitted by the transmitting rail vehicle to attempt to decrease the failure rate of communication from the transmitting rail vehicle. Conversely, if the rate of communication failure decreases below a threshold, then the input module 218 may inform the bandwidth module 222 and the bandwidth module 222 may decrease the size and/or number of portions of the bandwidth allocated to one or more categories of the data transmitted by the transmitting rail vehicle.

The bandwidth module 222 can dynamically allocate the bandwidth among the categories of data based on a change in the amount of bandwidth that is available through the communication pathway 116. For example, due to physical damage to the communication pathway 116, interference in communication within the communication pathway 116, an increase in the amount of data signal traffic in the communication pathway 116, and/or one or more external conditions, the amount of bandwidth that is available on the communication pathway 116 may change or decrease. The bandwidth module 222 may monitor the available bandwidth on the communication pathway 116. When the available bandwidth decreases below a threshold, the bandwidth module 222 may increase the size and/or number of portions of the bandwidth that are allocated to one or more categories of data having higher priority ranks and/or reduce the size and/or number of portions of the bandwidth allocated to other categories having lower priority ranks. In one embodiment, if the available bandwidth increases above a threshold, the bandwidth module 222 may change the size and/or number of portions of the bandwidth that are allocated to one or more categories of data, or may stop allocating bandwidth among the categories such that all or a plurality of the categories are transmitted using any or all of the available bandwidth.

A transceiver module 224 directs transmission of the data signals from one rail vehicle 200 or 202 to another rail vehicle 202 or 200 through the communication pathway 116. If the bandwidth module 222 has allocated different portions of the bandwidth of the communication pathway 116 to different categories of data, then the transceiver module 224 may transmit the data signals having the data using the allocated portions of the bandwidth. As described above, a transceiver module such as the router transceiver units 34a, 34b, 34c described in the '295 application may be used to transmit and/or receive data signals on the communication pathway 116. For example, the transceiver module 224 may include or be embodied in a router transceiver unit 34a, 34b, 34c to transmit and/or receive the data signals.

In one embodiment, the bandwidth module 222 throttles the available bandwidth for transmitting the data signals based on the priorities associated with the data signals by communicating the data signals through the communication pathway 116 using one or more layers of the Open Systems Interconnection (OSI) model of communication. For example, the data signals may be transmitted through the communication pathway 116 by the transceiver module 224 as data packets according to the TCP/IP protocol. The layers of the OSI model provide services to one or other layers of the OSI model to permit successful communication of the data packets from a transmitter to a receiver of the data packets, with the data packets being combined to form a data signal by the receiver of the data packets. For example, the network layer (also referred to as “Layer 3”) of the OSI model can provide for the routing of the data packets forming the data signal between communication components along a pathway between the transmitter and the receiver of the data signal. The communication components include one or more devices or modules that receive data packets and re-transmit the data packets between the transmitter and the receiver. In one embodiment, the communication components that route the data packets according to the network layer include transceiver modules 224 disposed in the consist 100, such as by being disposed on-board one or more powered units 104, 106, 108, 110 and/or non-powered units 112 of the consist 100. The transceiver module 224 that transmits the data packets can send the data packets to the transceiver module 224 on another unit 104, 106, 108, 110, 112, with the network layer routing the data packets through other transceiver modules 224 disposed between the transmitting transceiver module 224 and the receiving transceiver module 224. These other transceiver modules 224 receive and re-transmit the data packets so that the data packets end up at and are recombined at the receiving transceiver module 224.

The transport layer (also referred to as “Layer 4”) of the OSI model can provide for controlling the reliability in transmitting the data packets from the transmitting transceiver module 224 and the receiving transceiver module 224. For example, the transport layer can control the flow of the data packets (e.g., by changing the bandwidth allocated to communicating the data packets of different data signals), the segmentation and/or desegmentation of groups of packets and/or of individual packets (e.g., by combining data packets into groups and/or separating groups of data packets), and the like. The transport layer can control the order in which the data packets are transmitted so that the receiving transceiver module 224 receives the data packets in a predetermined order, such as in the order that the data packets are combined to form the data signal. The transport layer can provide error checking of the data packets, such as by examining the contents of the data packets to ensure the data included therein is not corrupted and/or by determining if the receiving transceiver module 224 actually receives the data packets.

The network and transport layers can be used to communicate the data signals over the communication pathway 116 that includes, or is formed from, the MU cable in the consist 100. For example, the transceiver modules 224 of the consist 100 and the communication pathway 116 may form interconnected components of a network, such as an Ethernet network. The network and transport layers may then be used to communicate the data packets of the data signal between the transceiver modules 224 and through the communication pathway 116. The network and transport layers may transmit the data packets according to the bandwidth allocations determined by the bandwidth module 222, and may provide quality of service (QoS) mechanisms to the communication of the data packets. For example, by assigning different priorities to the data signals, allocating different portions of available bandwidth according to the priorities, using the network layer to transmit the data packets along pathways in the Ethernet network according to the allocated portions of the bandwidth (e.g., higher priority signals having shorter paths through the network), and/or using the transport layer to provide more bandwidth to the data packets associated with higher priorities, a QoS mechanism that provides increased speed and/or reliability in transmitting higher priority data may be achieved.

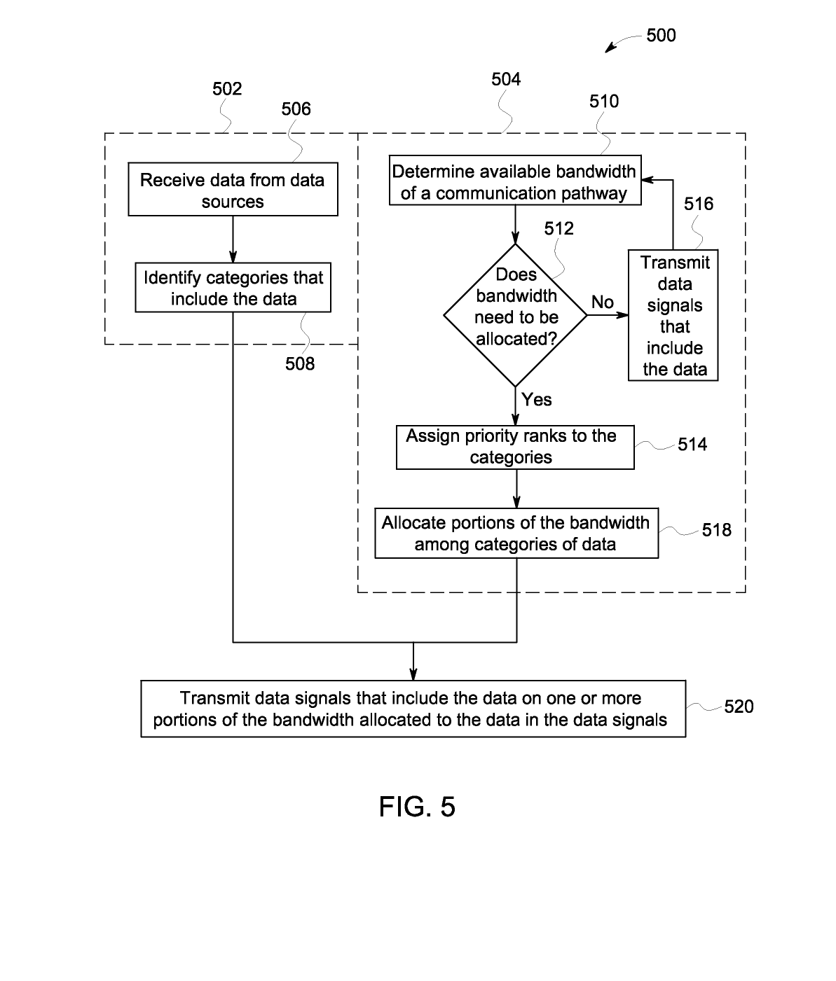

FIG. 5 is a flowchart of one embodiment of a method 500 for communicating data signals in a vehicle consist. The method 500 may be used in conjunction with one or more embodiments of the communication system 226 (shown in FIG. 2) to communicate data signals between rail vehicles 200, 202 (shown in FIG. 2) of the consist 100 (shown in FIG. 1). The method 500 is shown as including two legs 502, 504 that are referred to as a data acquisition leg 502 and a bandwidth allocation leg 504. The operations described in connection with the different legs 502, 504 may be performed at different times, during the same time periods, or during at least partially overlapping time periods.

In the data acquisition leg 502, at 506, data is received from one or more data sources. As described above, the processor 204 (shown in FIG. 2) on the rail vehicle 200 (shown in FIG. 2) may receive data from a variety of input sources, such as the sensor 208, the input device 210, the control device 212, the computer application 214, and the like (all shown in FIG. 2).

At 508, categories of the data are identified. For example, the data may be associated with one or more categories based on the data source that provided the data and/or the contents of the data. As described above, the categories may include a safety category, a control category, an informational category, a third party category, an inherent category, an other category, and the like.

In the allocation leg 504, at 510, an amount of available bandwidth on a communication pathway between the rail vehicles is determined. For example, the processor 204 (shown in FIG. 2) may determine how much bandwidth is available on the conductive communication pathway 116 (shown in FIG. 1) extending between the rail vehicles 200, 202 (shown in FIG. 2) for transmission of the data signals from the rail vehicle 200 to the rail vehicle 202. The bandwidth may be expressed as a bit rate for data transmission and/or a range of frequencies (Δf) that may be used to data transmission.

At 510, a determination is made as to whether the bandwidth of the communication pathway needs to be allocated. For example, the processor 204 (shown in FIG. 2) may determine if the amount of available bandwidth is relatively low, such as by being less than a bit rate threshold or frequency range threshold. If the amount of available bandwidth is relatively low, then the communication pathway may have insufficient resources to communicate data signals between the rail vehicles 200, 202 (shown in FIG. 2) without allocating the bandwidth among different categories of the data in the data signals. As a result, flow of the method 500 may continue to 514.

On the other hand, if the amount of available bandwidth is not relatively low, such as by being at least as great as a bit rate threshold or a frequency range threshold, then the communication pathway may have sufficient resources to communicate the data signals between the rail vehicles 200, 202 (shown in FIG. 2) without allocating the bandwidth among the categories of the data in the data signals. As a result, flow of the method may continue to 516.

At 516, data signals that include the data are transmitted from the rail vehicle 200 (shown in FIG. 2) to the rail vehicle 202 (shown in FIG. 2) without allocating the bandwidth of the communication pathway among the categories of data. Flow of the method 500 may return to 510 so that the method 500 proceeds in a loop-wise manner and the available bandwidth is repeatedly examined to determine if the bandwidth needs to be allocated. Alternatively, flow of the method 500 may not return to 510.

At 514, priority ranks are assigned to the categories of the data. For example, the categories of the data may be prioritized based on which data sources provided the data and/or the contents of the data. As described above, certain categories may receive a higher priority than other categories based on the type of data. For example, data related to the safe operation and/or control of the rail vehicles 200, 202 (shown in FIG. 2) may be provided with a higher priority rank than data that is provided for informational purposes only (e.g., a fuel level measurement or a cabin temperature measurement).

At 518, at least some of the available bandwidth of the communication pathway between the rail vehicles 200, 202 (shown in FIG. 2) is allocated among at least a plurality of the categories of the data. For example, the bandwidth may be divided into portions that are defined by subsets of different, discrete conductors (e.g., the physical portions 406 shown in FIG. 4) and/or subsets of the range of frequencies (Δf). The portions may be the same size or different sizes. One or more of the portions may be allocated to each of a plurality or all of the categories. As described above, categories having higher priority ranks may be allocated larger portions of the bandwidth and/or a larger number of portions of the bandwidth.

At 520, data signals that include the data are transmitted from the rail vehicle 200 (shown in FIG. 2) to the rail vehicle 202 (shown in FIG. 2). The data signals are transmitted through the communication pathway between the rail vehicles 200, 202. The data signals are transmitted using the portions of the bandwidth that are allocated based on the categories of the data. For example, a first data signal having data in a first category may be transmitted using a first portion of the bandwidth while a second data signal having data in a second category is transmitted using a different, second portion of the bandwidth. As described above, the data signals may be transmitted as network data comprised of data packets.

The method 500 may proceed in a loop-wise manner. For example, flow of the method 500 may return to 506 and/or 510 in order to obtain more data and/or allocate available bandwidth based on the categories of the data. The allocation of bandwidth may be fixed for a trip of the rail vehicles 200, 202 (shown in FIG. 2) or may be dynamically changed during the trip, as described above.

In one embodiment, a communication system for a first rail vehicle is provided. The system includes an input module, a bandwidth module, and a transceiver module. The input module is disposed on board the first rail vehicle and is configured to receive data from one or more data sources disposed on board the first rail vehicle. The bandwidth module is disposed on board the first rail vehicle and is configured to allocate different portions of a data communication bandwidth to data signals that include the data based on categories of the data. The categories represent at least one of a data source that provided the data or a content of the data. The bandwidth module is configured to allocate the portions of the data communication bandwidth that is available on a conductive communication pathway of the first rail vehicle. The transceiver module is disposed on board the first rail vehicle, the transceiver module configured to transmit the data signals through the conductive communication pathway using the portions of the bandwidth that are assigned to the data signals.

In another aspect, the system also includes a prioritization module disposed on board the first rail vehicle and configured to assign different priority ranks to the data signals based on the categories of the data included in the data signals. The bandwidth module is configured to allocate the portions of the data communication bandwidth based on the priority ranks of the data signals.

In another aspect, the conductive communication pathway includes a multiple unit (MU) cable extending from the first rail vehicle to a different, second rail vehicle.

In another aspect, the categories of the data include one or more of a control category having the data associated with controlling operations of a propulsion subsystem of one or more of the first rail vehicle or a different, second rail vehicle, a safety category having the data associated with enforcement of a safety limitation on operations of one or more of the first rail vehicle or the second rail vehicle, an informational category having the data representative of information about at least one of a state or condition of one or more of the first rail vehicle or the second rail vehicle, or a software application category having the data used by one or more software applications.

In another aspect, the different portions of the data communication bandwidth represent at least one of different physical portions of the communication pathway or subsets of a range of frequencies available for communicating the data signal through the communication pathway.

In another aspect, the bandwidth module is configured to allocate fixed portions of the data communication bandwidth among the categories of the data included in the data signals.

In another aspect, the bandwidth module is configured to allocate fixed portions of the data communication bandwidth among the categories of the data included in the data signals.

In another aspect, the fixed portions of the data communication bandwidth includes at least one of a fixed size of each of the portions of the data communication bandwidth or a fixed number of the portions of the data communication bandwidth.

In another aspect, the data sources interface with a plurality of physical ports of a connector that is coupled with the conductive communication pathway to communicate the data signals. The bandwidth module may be configured to allocate the fixed portions of the data communication bandwidth among the data sources based on the physical port of the connector to which each of the data sources is coupled.

In another aspect, the data sources are associated with different internet protocol (IP) addresses. The bandwidth module may be configured to allocate the fixed portions of the data communication bandwidth among the data sources based on the IP addresses of the data sources.

In another aspect, the bandwidth module is configured to dynamically allocate portions of the data communication bandwidth among the categories of the data included in the data signals.

In another aspect, the bandwidth module dynamically allocates the portions of the data communication bandwidth by changing an amount of the data communication bandwidth in a plurality of the portions one or more times during movement of the rail vehicle consist.

In another aspect, the bandwidth module is configured to dynamically allocate the portions of the data communication bandwidth by changing at least one of sizes of the portions or a number of the portions of the data communication bandwidth after the portions are initially allocated.

In another aspect, the bandwidth module is configured to dynamically allocate the portions of the data communications bandwidth based on at least one of an operating condition of the first rail vehicle, a failure rate of communication between the first rail vehicle and a different, second rail vehicle, or an amount of available data communication bandwidth on the conductive communication pathway.

In another embodiment, a method of communicating data signals with a first rail vehicle is provided. The method includes receiving data from one or more data sources disposed on board the first rail vehicle and allocating different portions of a data communication bandwidth to data signals that include the data based on categories of the data. The categories represent at least one of a data source that provided the data or a content of the data. The data communication bandwidth includes a bandwidth that is available on a conductive communication pathway of the first rail vehicle. The method also includes transmitting the data signals through the conductive communication pathway using the portions of the bandwidth that are assigned to the data signals.

In another aspect, the method also includes assigning different priority ranks to the data signals based on the categories of the data that is included in the data signals, where the allocating step includes allocating the portions of the data communication bandwidth based on the priority ranks.

In another aspect, the transmitting step includes transmitting the data signals through a multiple unit (MU) cable extending from the first rail vehicle to a different, second rail vehicle.

In another aspect, the allocating step includes allocating fixed portions of the data communication bandwidth among the categories of the data included in the data signals.

In another aspect, the fixed portions of the data communication bandwidth include at least one of a fixed size of each of the portions of the data communication bandwidth or a fixed number of the portions of the data communication bandwidth.

In another aspect, the data sources interface with a plurality of physical ports of a connector that is coupled with the conductive communication pathway to communicate the data signals, and the allocating step includes allocating the fixed portions of the data communication bandwidth among the data sources based on the physical port of the connector to which each of the data sources is coupled.

In another aspect, the data sources are associated with different internet protocol (IP) addresses. The allocating step may include allocating the fixed portions of the data communication bandwidth among the data sources based on the IP addresses of the data sources.

In another aspect, the allocating step includes dynamically allocating portions of the data communication bandwidth among the categories of the data included in the data signals.

In another aspect, the allocating step includes changing at least one of sizes of the portions or a number of the portions of the data communication bandwidth after the portions are initially allocated.

In another aspect, the allocating step includes allocating the portions of the data communications bandwidth based on at least one of an operating condition of the first rail vehicle, a failure rate of communication between the first rail vehicle and a different, second rail vehicle, or an amount of available data communication bandwidth on the conductive communication pathway.

In another aspect, the categories of the data include one or more of a control category having the data associated with controlling operations of a propulsion subsystem of one or more of the first rail vehicle or a different, second rail vehicle, a safety category having the data associated with enforcement of a safety limitation on operations of one or more of the first rail vehicle or the second rail vehicle, an informational category having the data representative of information about at least one of a state or condition of one or more of the first rail vehicle or the second rail vehicle, or a software application category having the data used by one or more software applications.

In another aspect, the different portions of the data communication bandwidth represent different physical portions of the communication pathway.

In another embodiment, a computer readable storage medium having one or more sets of instructions is provided. The one or more sets of instructions direct the processor to receive data from one or more data sources disposed on board a first rail vehicle and allocate different portions of a data communication bandwidth to data signals that include the data based on categories of the data. The categories represent at least one of a data source that provided the data or a content of the data. The data communication bandwidth includes a bandwidth that is available on a conductive communication pathway of the first rail vehicle. The one or more sets of instructions also direct the processor to transmit the data signals through the conductive communication pathway using the portions of the bandwidth that are assigned to the data signals.

In another aspect, the computer readable storage medium is a tangible and non-transitory medium.

In another aspect, the one or more sets of instructions direct the processor to assign different priority ranks to the data signals based on the categories of the data that is included in the data signals and allocate the portions of the bandwidth based on the priority ranks.

In another aspect, the one or more sets of instructions direct the processor to transmit the data signals through a multiple unit (MU) cable extending from the first rail vehicle to a different, second rail vehicle.

In another aspect, the one or more sets of instructions direct the processor to allocate at least one of physical portions of the data communication bandwidth or subsets of a range of frequencies available for transmission of the data signals through the communication pathway.

In another aspect, the one or more sets of instructions direct the processor to allocate fixed portions of the data communication bandwidth.

In another aspect, the fixed portions include at least one of a fixed size of each of the portions of the data communication bandwidth or a fixed number of the portions of the data communication bandwidth.

In another aspect, the data sources interface with a plurality of physical ports of a connector that is coupled with the conductive communication pathway to communicate the data signals. The one or more sets of instructions may direct the processor to allocate the fixed portions of the data communication bandwidth among the data sources based on the physical port of the connector to which each of the data sources is coupled.

In another aspect, the data sources are associated with different internet protocol (IP) addresses. The one or more sets of instructions may direct the processor to allocate the fixed portions of the data communication bandwidth among the data sources based on the IP addresses of the data sources.

In another aspect, the one or more sets of instructions direct the processor to dynamically allocate portions of the data communication bandwidth among the categories of the data included in the data signals.

In another aspect, the one or more sets of instructions direct the processor to allocate the portions of the data communications bandwidth based on at least one of an operating condition of the first rail vehicle, a failure rate of communication between the first rail vehicle and a different, second rail vehicle, or an amount of available data communication bandwidth on the conductive communication pathway.

In another aspect, the one or more sets of instructions direct the processor to change at least one of sizes of the portions or a number of the portions of the data communication bandwidth after the portions are initially allocated.

In another aspect, the categories of the data include one or more of a control category having the data associated with controlling operations of a propulsion subsystem of one or more of the first rail vehicle or a different, second rail vehicle, a safety category having the data associated with enforcement of a safety limitation on operations of one or more of the first rail vehicle or the second rail vehicle, an informational category having the data representative of information about at least one of a state or condition of one or more of the first rail vehicle or the second rail vehicle, or a software application category having the data used by one or more software applications.

In another aspect, the different portions of the data communication bandwidth represent different physical portions of the communication pathway. Another embodiment relates to a communication system comprising a bandwidth module and a transceiver module. The bandwidth module is configured to allocate different portions of a data communication bandwidth of a communication pathway to data signals that include data received from one or more data sources disposed on board a rail vehicle. The allocation is based on categories of the data; the categories represent contents of the data and/or the data sources. The transceiver module is configured to transmit the data signals through the communication pathway using the portions of the bandwidth that are allocated to the data signals. In embodiments: the bandwidth module and the transceiver module are configured to be operatively coupled together, and when deployed for operation, are so coupled; and/or the bandwidth module and the transceiver module are integrated together as part of a common electronics unit; and/or the bandwidth module and the transceiver module are configured to be operatively disposed on board the rail vehicle, and when deployed for operation, are so disposed; and/or the transceiver module is configured to be operatively coupled with the communication pathway, and when deployed for operation, is so coupled.

In another embodiment of the communication system, the system further comprises an input module configured to receive the data from the one or more data sources disposed on board the first rail vehicle. The input module is further configured to be operatively coupled with at least one of the bandwidth module or the transceiver module, and for operation, is so coupled. In embodiments, the input module, bandwidth module, and the transceiver module are integrated together as part of a common electronics unit or module. Another embodiment relates to a communication system comprising an input module, a bandwidth module, and a transceiver module. The input module is configured to receive data from one or more data sources disposed on board a first rail vehicle. The bandwidth module is configured to be operatively coupled with the input module, and is configured to allocate different portions of a data communication bandwidth of a communication pathway to data signals that include the data. The allocation is based on categories of the data. (In other words, the bandwidth module is configured to allocate the different portions of the bandwidth based on the categories of the data.) The categories represent at least one of the one or more data sources that provided the data or contents of the data. The transceiver module is configured to be operatively coupled with the communication pathway, and with at least one of the bandwidth module or the input module. The transceiver module is further configured to transmit the data signals through the communication pathway using the portions of the bandwidth that are allocated to the data signals. The input module, bandwidth module, and transceiver module may be configured to be disposed on board the first rail vehicle (e.g., configured for operative coupling with one or more systems of the first rail vehicle), and subsequent to deployment for operation, the input module, bandwidth module, and transceiver module are so disposed. In embodiments, the input module, bandwidth module, and transceiver module are integrated into a common electronic unit; in other embodiments, they are distributed or separate but configured to communicate with one another as applicable.

Another embodiment relates to a communication system for a first rail vehicle. The system comprises an input module, a bandwidth module, and a transceiver module. The input module is disposed on board the first rail vehicle, and is configured to receive data from one or more data sources disposed on board the first rail vehicle. The bandwidth module is disposed on board the first rail vehicle, and is configured to allocate, based on categories of the data, different portions of a data communication bandwidth of a communication pathway to data signals that include the data. The categories represent at least one of contents of the data or the data sources. The transceiver module is disposed on board the first rail vehicle, and is configured to transmit the data signals through the communication pathway using the portions of the bandwidth that are allocated to the data signals. In an embodiment, the input module, bandwidth module, and transceiver module are operatively coupled to one another.

Another embodiment relates to a communication transceiver system, which is configured for operative coupling on board a rail vehicle. The communication transceiver system is configured to be operatively coupled with a communication pathway of the rail vehicle. The communication pathway has a bandwidth. The communication transceiver system is configured to receive data from one or more data sources disposed on board the first rail vehicle. The communication transceiver system is configured to transmit data signals, containing the data, over plural channels (sub-divisions) of at least a portion of the bandwidth, as a function of the data sources and/or the contents of the data. In other words, the particular channel that a data signal is transmitted over is based on the content and/or data source of the data of the data signal. The plural channels may be the same size or different sizes. The number and/or sizes of the channels apportioned to the data signals, as a function of source and/or content, may be established based on the data sources and/or the content of the data. For example, in the case of first data and second data, where the first data is considered relatively higher priority and the second data is considered relatively lower priority, the first data may be transmitted over a larger number of same-sized channels and/or over a single channel having a larger bandwidth, than the number or bandwidth of channel(s) over which the second data is transmitted.

Another embodiment relates to a communication system comprising a transceiver (e.g., transceiver module) and a control element (e.g., bandwidth module). The transceiver is configured to be operatively coupled with one or more electrical conductors of a rail vehicle (e.g., MU cable), and when deployed for operation, is so coupled. The control element is configured to be operatively coupled with the transceiver, and when deployed for operation, is so coupled; in embodiments, the transceiver and control element are integrated together in an electronics unit. The control element is further configured to control the transceiver for transmission of data signals over the one or more electrical conductors. The control element is further configured to allocate portions of a bandwidth of the one or more electrical conductors to the data signals based on at least one of contents or sources of data in the data signals. The data may be received from sources on board the rail vehicle.

Another embodiment relates to a method for communicating data signals. The method comprises transmitting data signals through a communication pathway of a rail vehicle. The communication pathway has a bandwidth across a designated frequency range. The bandwidth is divided into different channels (allocated bandwidth subdivisions) as a function of the content of the data included in the data signals and/or the sources of the data included in the data signals. For example, the number and/or respective sizes of the channels (which may be different from one another) may be based on the sources and/or content of the data. The data signals are transmitted through particular ones of the channels depending on the sources and/or content of the data they contain. The designated frequency range may be a frequency range of electronic equipment used to transmit the data signals over the communication pathway or a total available bandwidth of the communication pathway, whichever is smaller.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the disclosed subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable a person of ordinary skill in the art to practice the embodiments of invention, including making and using any devices or systems and performing any incorporated methods. The patentable scope of the invention is defined by the claims, and may include other examples that occur to one of ordinarily skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present invention will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described communication system and method for vehicle consist, without departing from the spirit and scope of the invention herein involved, it is intended that all of the subject matter of the above description or shown in the accompanying drawings shall be interpreted merely as examples illustrating the inventive concept herein and shall not be construed as limiting the inventive subject matter.

What is claimed is:

1. A communication system comprising:
a bandwidth module configured to allocate different portions of a data communication bandwidth of a communication pathway to data signals that include data received from one or more data sources disposed on board a rail vehicle, wherein the allocation is based on categories of the data, the categories representing at least one of the one or more data sources or contents of the data; and
a transceiver module configured to transmit the data signals through the communication pathway using the portions of the bandwidth that are allocated to the data signals.

2. The system of claim 1, further comprising a prioritization module configured to assign different priority ranks to the data signals based on the categories of the data included in the data signals, wherein the bandwidth module is configured to allocate the portions of the data communication bandwidth based on the priority ranks of the data signals.

3. The system of claim 1, wherein the communication pathway is a conductive communication pathway comprising a multiple unit (MU) cable extending from the first rail vehicle to a different, second rail vehicle.

4. The system of claim 1, wherein the categories of the data include one or more of:
a first category comprising data associated with controlling operations of a propulsion subsystem of one or more of the first rail vehicle or a different, second rail vehicle;
a second category comprising data associated with enforcement of a safety limitation on operations of one or more of the first rail vehicle or the second rail vehicle;
a third category comprising data representative of information about at least one of a state or condition of one or more of the first rail vehicle or the second rail vehicle; or
a fourth category comprising data used by one or more software applications.

5. The system of claim 1, wherein the different portions of the data communication bandwidth represent at least one of different physical portions of the communication pathway or subsets of a range of frequencies available for communicating the data signals through the communication pathway.

6. The system of claim 1, wherein the bandwidth module is configured to allocate physical portions of the data communication bandwidth among the categories of the data included in the data signals.

7. The system of claim 1, wherein the bandwidth module is configured to dynamically allocate the portions of the data communication bandwidth among the categories of the data included in the data signals.

8. The system of claim 7, wherein the bandwidth module is configured to dynamically allocate the portions of the data communication bandwidth by changing respective amounts of the data communication bandwidth in a plurality of the portions one or more times during movement of the first rail vehicle.

9. The system of claim 7, wherein the bandwidth module is configured to dynamically allocate the portions of the data communications bandwidth based on at least one of an operating condition of the first rail vehicle, a failure rate of communication between the first rail vehicle and a different, second rail vehicle, or an amount of available data communication bandwidth on the communication pathway.

10. The system of claim 1, further comprising an input module configured to be operatively coupled with at least one of the bandwidth module or the transceiver module and further configured to receive the data from the one or more data sources disposed on board the first rail vehicle.

11. A method of communicating data signals, the method comprising:
receiving data from one or more data sources disposed on board a first rail vehicle;
allocating different portions of a data communication bandwidth to data signals that include the data based on categories of the data, the categories representative of at least one of the one or more data sources or contents of the data, the data communication bandwidth including a bandwidth that is available on a communication pathway of the first rail vehicle; and
transmitting the data signals through the communication pathway using the portions of the bandwidth that are assigned to the data signals.

12. The method of claim 11, further comprising assigning different priority ranks to the data signals based on the categories of the data that is included in the data signals, wherein the allocating step includes allocating the portions of the data communication bandwidth based on the priority ranks.

13. The method of claim 11, wherein the communication pathway comprises a conductive communication pathway including a multiple unit (MU) cable, and the transmitting step includes transmitting the data signals through the MU cable extending from the first rail vehicle to a different, second rail vehicle.

14. The method of claim 11, wherein the allocating step includes dynamically allocating the portions of the data communication bandwidth among the categories of the data included in the data signals.

15. The method of claim 14, wherein the allocating step includes changing at least one of sizes of the portions or a number of the portions of the data communication bandwidth after the portions are initially allocated.

16. A computer readable storage medium including one or more sets of instructions that direct a processor to:
receive data from one or more data sources disposed on board a first rail vehicle;
allocate different portions of a data communication bandwidth to data signals that include the data based on categories of the data, the categories representative of at least one of the one or more data sources or contents of the data, the data communication bandwidth including a bandwidth that is available on a communication pathway of the first rail vehicle; and
transmit the data signals through the communication pathway using the portions of the bandwidth that are assigned to the data signals.

17. The computer readable storage medium of claim 16, wherein the one or more sets of instructions direct the processor to:
assign different priority ranks to the data signals based on the categories of the data that is included in the data signals; and
allocate the portions of the bandwidth based on the priority ranks.

18. The computer readable storage medium of claim 16, wherein the one or more sets of instructions direct the processor to transmit the data signals through a multiple unit (MU) cable of the first rail vehicle.

19. The computer readable storage medium of claim 16, wherein the one or more sets of instructions direct the processor to allocate at least one of physical portions of the data communication bandwidth or subsets of a range of frequencies available for transmission of the data signals through the communication pathway.

20. The computer readable storage medium of claim 16, wherein the one or more sets of instructions direct the processor to dynamically allocate portions of the data communication bandwidth among the categories of the data included in the data signals.

21. The computer readable storage medium of claim 20, wherein the one or more sets of instructions direct the processor to allocate the portions of the data communications bandwidth based on at least one of an operating condition of the first rail vehicle, a failure rate of communication between the first rail vehicle and a different, second rail vehicle; or
an amount of available data communication bandwidth on the communication pathway.

22. A communication system for a first rail vehicle, the system comprising:
an input module disposed on board the first rail vehicle, the input module configured to receive data from one or more data sources disposed on board the first rail vehicle;
a bandwidth module disposed on board the first rail vehicle, the bandwidth module configured to allocate, based on categories of the data, different portions of a data communication bandwidth of a communication pathway to data signals that include the data, the categories representing at least one of contents of the data or the data sources; and
a transceiver module disposed on board the first rail vehicle, the transceiver module configured to transmit the data signals through the communication pathway using the portions of the bandwidth that are allocated to the data signals.

23. A communication system comprising:
a transceiver configured to be operatively coupled with one or more electrical conductors of a rail vehicle; and
a control element configured to control the transceiver for transmission of data signals over the one or more electrical conductors, wherein the control element is further configured to allocate portions of a bandwidth of the one or more electrical conductors to the data signals based on at least one of contents or sources of data in the data signals.
